(19) United States
(12) Patent Application Publication
(10) Pub. No.: US 2024/0418023 A1
(43) Pub. Date: Dec. 19, 2024

(54) MOVABLE DOOR STRUCTURE

(71) Applicant: Qisda Corporation, Taoyuan City (TW)

(72) Inventor: Yen Juei Huang, Taoyuan City (TW)

(73) Assignee: Qisda Corporation, Taoyuan City (TW)

(21) Appl. No.: 18/642,722

(22) Filed: Apr. 22, 2024

(30) Foreign Application Priority Data
Jun. 15, 2023 (CN) 202310710198.1

(51) Int. Cl. E05D 15/06; E05F 1/16

(52) U.S. Cl. CPC E05D 15/0621; E05F 1/16; E05Y 2201/474; E05Y 2600/62; E05Y 2600/626

(57) ABSTRACT

A movable door structure includes a bracket, a door panel, and an elastic element. The bracket disposed in a machine shell includes at least one curved slide rail including a first section and a second section communicating with each other. There is a bending angle between a first extension direction of the first section and a second extension direction of the second section. The door panel disposed on the bracket is suitable for sliding along the at least one curved slide rail. When the elastic element connected between an inner surface of the door panel and an abutment portion of the machine shell pushes against the door panel, so that the door panel is located at a first position, the door panel covers an opening of the machine shell, and an exterior surface of the door panel is aligned with an outer surface of the machine shell.

### CROSS-REFERENCE TO RELATED APPLICATION

This application claims the priority benefit of China application serial no. 202310710198.1, filed on Jun. 15, 2023. The entirety of the above-mentioned patent application is hereby incorporated by reference herein and made a part of this specification.

### BACKGROUND

### Technical Field

The invention relates to a door structure, and in particular to a movable door structure.

### Description of Related Art

Generally speaking, a joint of an existing machine configured to insert an accessory directly opens a hole on a surface of the machine, so that an exterior surface of the machine is uneven, and dust easily enters the machine. Therefore, how to open the hole for inserting the accessory in a limited space or without occupying extra space and to provide the machine with a dust-proof function is indeed one of the issues that relevant personnel need to think about and solve.

### SUMMARY

The invention provides a movable door structure which may provide a door panel with an opening for automatically opening and closing a machine shell without occupying extra space to achieve purposes of convenient usage and dust-proof.

The movable door structure of the invention is suitable for being assembled in a machine shell. The machine shell includes an abutment portion and has an opening and an outer surface. The movable door structure includes a bracket, a door panel, and an elastic element. The bracket is disposed in the machine shell and includes at least one curved slide rail. The at least one curved slide rail includes a first section and a second section communicating with each other. There is a bending angle between a first extension direction of the first section and a second extension direction of the second section. The door panel is disposed on the bracket and is suitable for sliding along the at least one curved slide rail. The door panel has an exterior surface and an inner surface opposite to each other. The elastic element is connected between the inner surface of the door panel and the abutment portion of the machine shell. When the elastic element pushes against the door panel, so that the door panel is located at a first position, the door panel covers the opening of the machine shell, and the exterior surface of the door panel is aligned with the outer surface of the machine shell.

In an embodiment of the invention, the bending angle is between 10 degrees and 45 degrees.

In an embodiment of the invention, the at least one curved slide rail of the bracket includes a first curved slide rail and a second curved slide rail. The bracket further includes a first side panel and a second side panel parallel to each other. The first curved slide rail is disposed on the first side panel, and the second curved slide rail is disposed on the second side panel.

In an embodiment of the invention, the door panel includes a body and two bolts. The body is located between the first curved slide rail and the second curved slide rail. The two bolts are respectively inserted into the first curved slide rail and the second curved slide rail and are suitable for sliding along the first curved slide rail and the second curved slide rail, so that the door panel moves between the first position and a second position.

In an embodiment of the invention, a shape of the opening of the machine shell matches a shape of the body of the door panel, and a thickness of the body is equal to a diameter of the opening.

In an embodiment of the invention, the bracket further includes a support panel and an extension panel. The support panel connects the first side panel and the second side panel, and a third extension direction of the support panel is perpendicular to a fourth extension direction of the first side panel and the second side panel. The extension panel is connected to the support panel, and a fifth extension direction of the extension panel is parallel to the fourth extension direction of the first side panel and the second side panel.

In an embodiment of the invention, the bracket further includes a buckle portion disposed on a lower surface of the extension panel and facing the elastic element.

In an embodiment of the invention, there is an accommodation space between the bracket and the machine shell. When an accessory pushes against the exterior surface of the door panel and enters the accommodation space, the buckle portion buckles the accessory to limit a movement of the accessory, and the door panel resists an elastic force of the elastic element and is located at the second position. The accommodation space accommodates the door panel and the elastic element.

In an embodiment of the invention, the first side panel, the second side panel, the support panel, the extension panel, and the buckle portion are integrally formed.

In an embodiment of the invention, the buckle portion has flexibility.

Based on the above, in a design of the movable door structure of the invention, the door panel may slide along the curved slide rail of the bracket, and the elastic element is connected between the inner surface of the door panel and the abutment portion of the machine shell. Therefore, there is no need to reserve a rotation space for the door panel in the machine shell, and the door panel may have a rebound function through a configuration of the elastic element. That is, the door panel may automatically open and close the opening of the machine shell to achieve the purpose of convenient usage. Moreover, when the elastic element pushes against the door panel, so that the door panel is located at the first position, the door panel may cover the opening of the machine shell, and the exterior surface of the door panel may be aligned with the outer surface of the machine shell, so as to achieve the purpose of dust-proof. In short, the movable door structure of the invention may provide the opening for automatically opening and closing the machine shell without occupying extra space to achieve the purposes of convenient usage and dust-proof.

In order to make the aforementioned features and advantages of the invention more comprehensible, embodiments accompanying drawings are described in detail as follows.

### BRIEF DESCRIPTION OF THE DRAWINGS

FIG. 1 is a schematic three-dimensional view of a movable door structure assembled in a machine shell according to an embodiment of the invention.

FIG. 2 is a schematic three-dimensional view of the movable door structure of FIG. 1.

FIG. 3 is a schematic three-dimensional view of FIG. 2 from another perspective.

FIG. 4 is a schematic cross-sectional view along line I-I of FIG. 1.

FIG. 5 is a schematic three-dimensional view of an accessory inserted into the machine shell of FIG. 1.

FIG. 6 is a schematic cross-sectional view along line II-II of FIG. 5.

### DESCRIPTION OF THE EMBODIMENTS

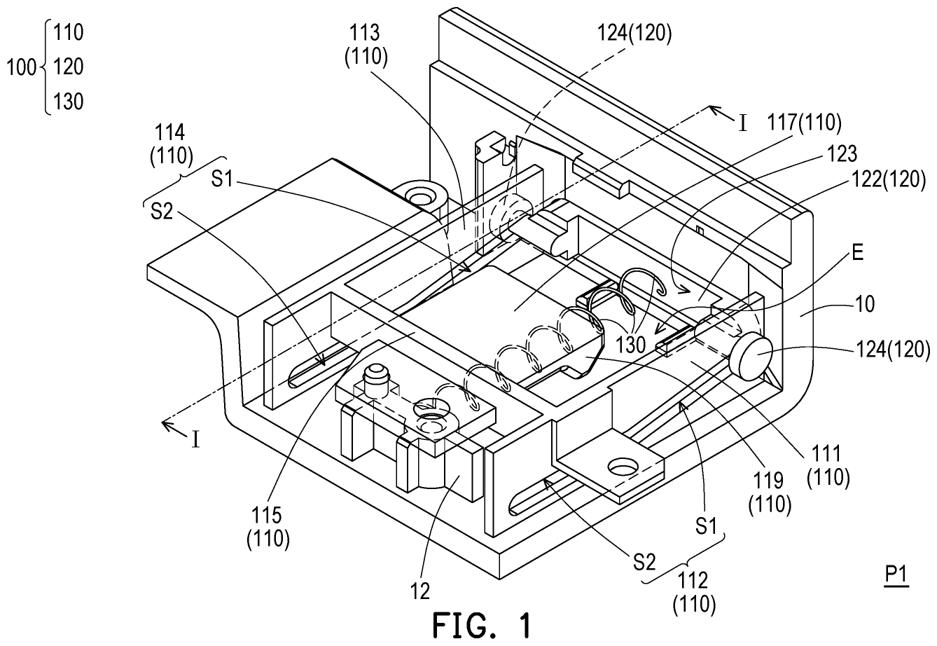

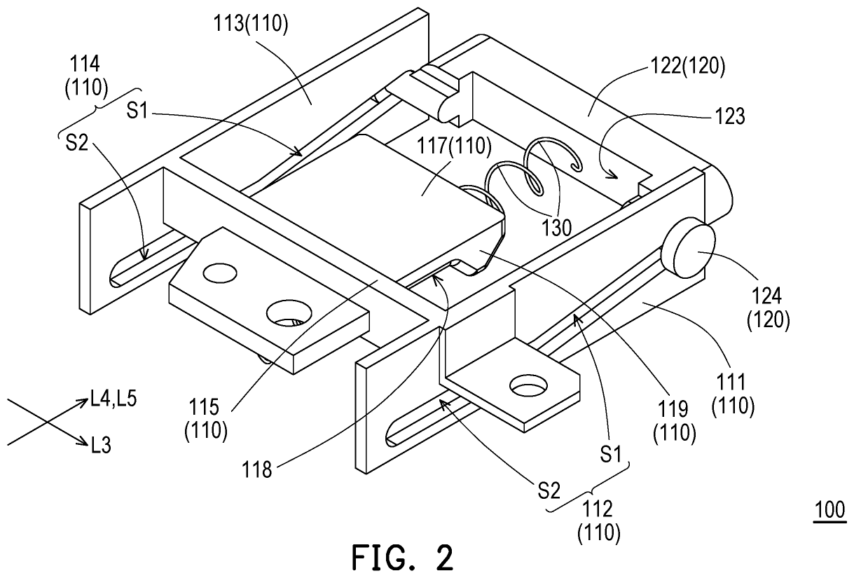

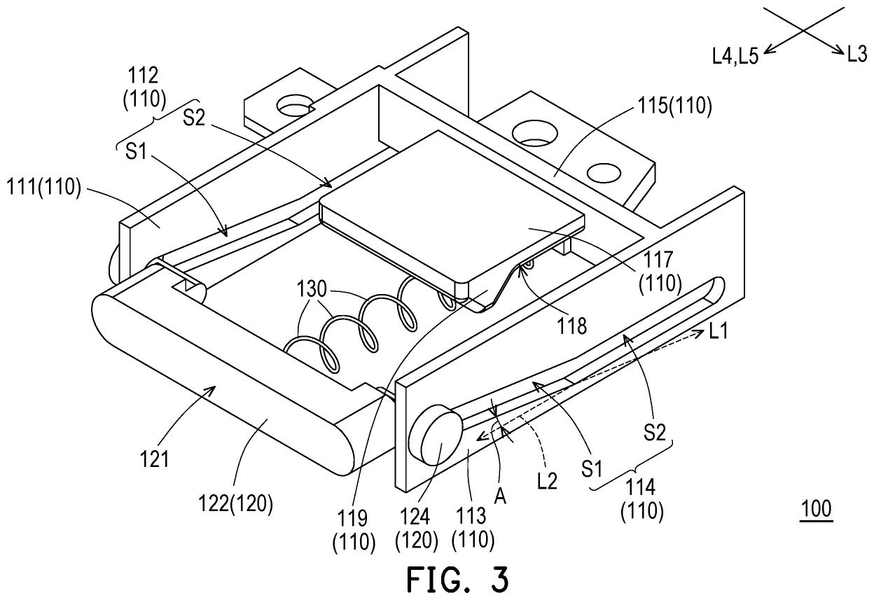

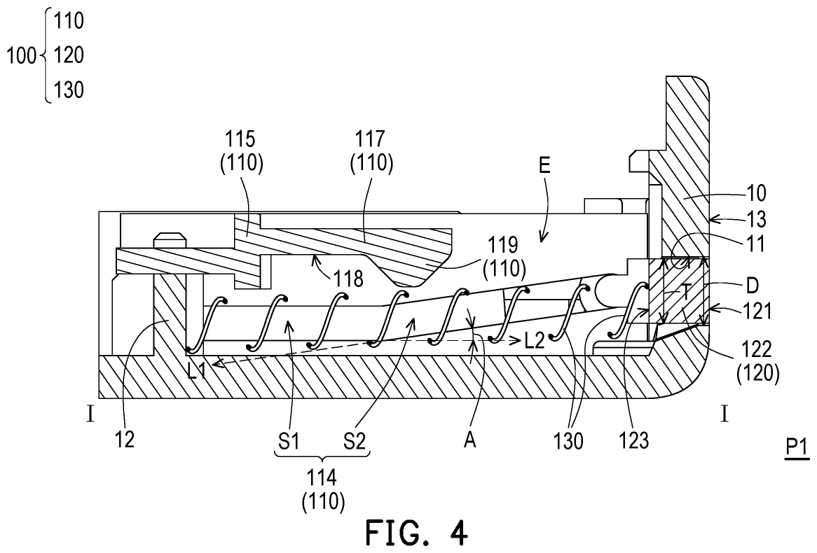

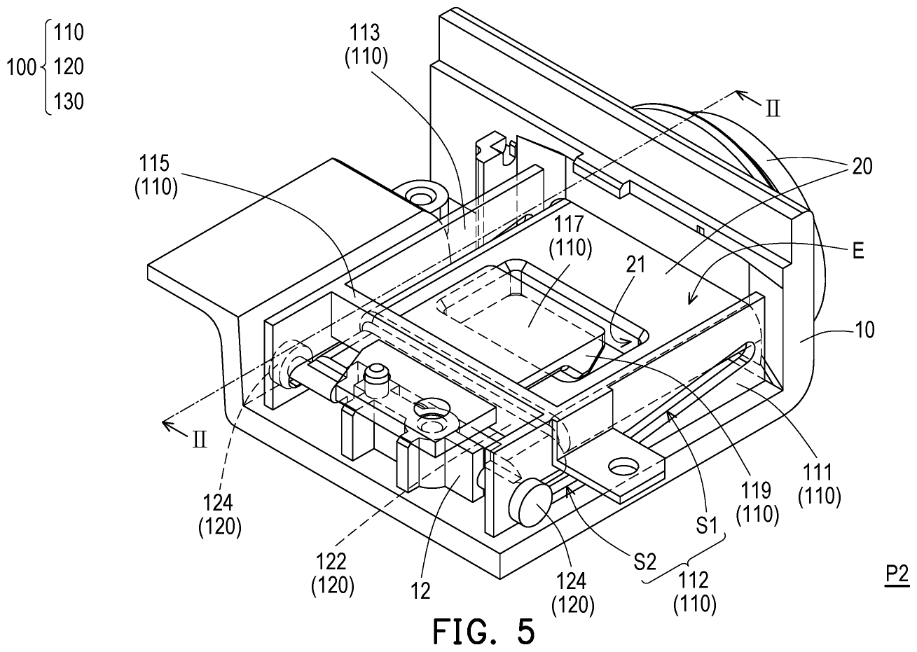

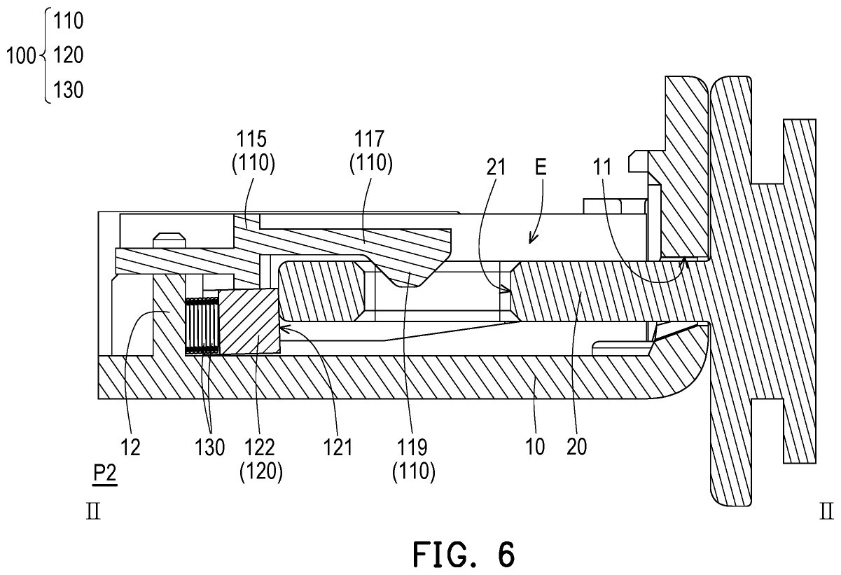

FIG. 1 is a schematic three-dimensional view of a movable door structure assembled in a machine shell according to an embodiment of the invention. FIG. 2 is a schematic three-dimensional view of the movable door structure of FIG. 1. FIG. 3 is a schematic three-dimensional view of FIG. 2 from another perspective. FIG. 4 is a schematic cross-sectional view along line I-I of FIG. 1. FIG. 5 is a schematic three-dimensional view of an accessory inserted into the machine shell of FIG. 1. FIG. 6 is a schematic cross-sectional view along line II-II of FIG. 5.

Referring to FIG. 1, FIG. 2, FIG. 3, and FIG. 4 at the same time, in this embodiment, a movable door structure 100 is suitable for being assembled in a machine shell 10, wherein the machine shell 10 includes an abutment portion 12 and has an opening 11 and an outer surface 13. The movable door structure 100 includes a bracket 110, a door panel 120, and an elastic element 130. The bracket 110 is disposed in the machine shell 10 and includes at least one curved slide rail (two curved slide rails are schematically illustrated, namely a first curved slide rail 112 and a second curved slide rail 114). The first curved slide rail 112 and the second curved slide rail 114 respectively include a first section S1 and a second section S2 communicating with each other. There is a bending angle A between a first extension direction L1 of the first section S1 and a second extension direction L2 of the second section S2. The door panel 120 is disposed on the bracket 110 and is suitable for sliding along the first curved slide rail 112 and the second curved slide rail 114. The door panel 120 has an exterior surface 121 and an inner surface 123 opposite to each other. The elastic element 130 is connected between the inner surface 123 of the door panel 120 and the abutment portion 12 of the machine shell 10. When the elastic element 130 pushes against the door panel 120, so that the door panel 120 is located at a first position P1, the door panel 120 covers the opening 11 of the machine shell 10, and the exterior surface 121 of the door panel 120 is aligned with the outer surface 13 of the machine shell 10, so as to achieve a dust-proof effect inside the machine shell 10.

Further, referring to FIG. 2 and FIG. 3 at the same time, the bracket 110 of the movable door structure 100 of this embodiment further includes a first side panel 111 and a second side panel 113 parallel to each other. The first curved slide rail 112 is disposed on the first side panel 111, and the second curved slide rail 114 is disposed on the second side panel 113. Since the first curved slide rail 112 and the second curved slide rail 114 respectively have a special design of the bending angle A, wherein the bending angle A is, for example, between 10 degrees and 45 degrees, the bending angle A is configured to enable the door panel 120 to deviate from a preset plugging position/an electricity connection port of the accessory 20 when the door panel 120 is shifted by the inserted accessory 20 (referring to FIG. 5 and FIG. 6), which can avoid interference with a slot 21 of the accessory 20. If the bending angle A is greater than 45 degrees, a user may have a problem of poor usage feel when inserting the accessory 20. If an angle of the bending angle A is not limited, the door panel 120 may easily interfere structurally with the bracket 110 when the door panel 120 is shifted by the inserted accessory 20 (referring to FIG. 5 and FIG. 6).

It should be noted that in this embodiment, the bracket 110 includes the first curved slide rail 112 and the second curved slide rail 114 symmetrical to each other, so as to enable the door panel 120 to have better balanced sliding, but is not limited thereto. In an unillustrated embodiment, the bracket may also be disposed with a curved slide rail on only one side of the side panel, that is, only one curved slide rail. The door panel slides through this curved slide rail, which is still within the scope of the invention.

Moreover, the bracket 110 of this embodiment further includes a support panel 115 and an extension panel 117. The support panel 115 connects the first side panel 111 and the second side panel 113, and a third extension direction L3 of the support panel 115 is perpendicular to a fourth extension direction L4 of the first side panel 111 and the second side panel 113. The extension panel 117 is connected to the support panel 115, and a fifth extension direction L5 of the extension panel 117 is parallel to the fourth extension direction L4 of the first side panel 111 and the second side panel 113. In addition, the bracket 110 further includes a buckle portion 119 disposed on a lower surface 118 of the extension panel 117 and facing the elastic element 130. Here, the extension panel 117 may be regarded as a cantilever beam, and the buckle portion 119 is disposed at one end of the extension panel 117 and has flexibility. Therefore, the buckle portion 119 is configured to remove the accessory 20 snapped and inserted between the first curved slide rail 112 and the second curved slide rail 114 and prevents the inserted accessory 20 from being pushed out of the door panel 120 by tension of the elastic element 130. In an embodiment, the first side panel 111, the second side panel 113, the support panel 115, the extension panel 117, and the buckle portion 119 of the bracket 110 are, for example, an integrally formed structure, but are not limited thereto.

Referring to FIG. 1 and FIG. 4 again, in this embodiment, a shape of the opening 11 of the machine shell 10 matches a shape of the body 122 of the door panel 120, wherein a thickness T of the body 122 is equal to or slightly smaller than a diameter D of the opening 11. That is, the body 122 may completely cover/fill the opening 11 of the machine shell 10. There is an accommodation space E between the bracket 110 and the machine shell 10. As shown in FIG. 5 and FIG. 6, when the accessory 20 pushes against the exterior surface 121 of the door panel 120 and enters the accommodation space E, the buckle portion 119 of the bracket 110 may buckle the slot 21 of the accessory 20 to limit a movement of the accessory 20, and the door panel 120 resists an elastic force of the elastic element 130 and slide along the first curved slide rail 112 and the second curved slide rail 114 to be located at the second position P2. At this time, the accommodation space E may accommodate the door panel 120 and the compressed elastic element 130.

In addition, referring to FIG. 2 and FIG. 3 again, the door panel 120 of this embodiment includes a body 122 and two bolts 124. The body 122 is located between the first curved slide rail 112 and the second curved slide rail 114. The two bolts 124 are respectively inserted into the first curved slide rail 112 and the second curved slide rail 114 and are suitable for sliding along the first curved slide rail 112 and the second curved slide rail 114, so that the door panel 120 moves between the first position P1 (referring to FIG. 1 and FIG. 4) and the second position P2 (referring to FIG. 5 and FIG. 6). That is to say, the door panel 120 may perform a reciprocating motion according to guidance of shapes of the first curved slide rail 112 and the second curved slide rail 114. Here, a configuration of the two bolts 124 can prevent the body 122 from skew interference when sliding. In addition, the elastic element 130 of this embodiment is, for example, a compression spring, but is not limited thereto.

In this embodiment, since the elastic element 130 is connected between the inner surface 123 of the door panel 120 and the abutment portion 12 of the machine shell 10, the door panel 120 may have a rebound function through a configuration of the elastic element 130. That is, the door panel 120 may automatically open and close the opening 11 of the machine shell 10 to achieve a purpose of convenient usage. Moreover, the first curved slide rail 112 and the second curved slide rail 114 of this embodiment respectively have the design of the bending angle A, which can take into account the feel and avoid structural interference. The door panel 120 may slide along the first curved slide rail 112 and the second curved slide rail 114. Therefore, there is no need to reserve a rotation space for the door panel in the machine shell 10, that is, no extra space is occupied. In addition, the door panel 120 of this embodiment is supported against the opening 11 of the machine shell 10 through the tension of the elastic element 130, so that the body 122 of the door panel 120 may cover or fill the opening 11 of the machine shell 10, wherein the exterior surface 121 of the door panel 120 may be aligned with the outer surface 13 of the machine shell 10, so as to achieve the purpose of dust-proof.

To sum up, in the design of the movable door structure of the invention, the door panel may slide along the curved slide rail of the bracket, and the elastic element is connected between the inner surface of the door panel and the abutment portion of the machine shell. Therefore, there is no need to reserve the rotation space for the door panel in the machine shell, and the door panel may have the rebound function through the configuration of the elastic element. That is, the door panel may automatically open and close the opening of the machine shell to achieve the purpose of convenient usage. Moreover, when the elastic element pushes against the door panel, so that the door panel is located at the first position, the door panel may cover the opening of the machine shell, and the exterior surface of the door panel may be aligned with the outer surface of the machine shell, so as to achieve the purpose of dust-proof. In short, the movable door structure of the invention may provide with the opening for automatically opening and closing the machine shell without occupying extra space, so as to achieve the purposes of convenient usage and dust-proof.

Although the invention has been disclosed above through embodiments, the embodiments are not intended to limit the invention. A person having ordinary knowledge in the art may make some changes and modifications without departing from the spirit and scope of the invention. Therefore, the protection scope of the invention shall be defined by the appended claims.

What is claimed is:

1. A movable door structure, suitable for being assembled in a machine shell, wherein the machine shell comprises an abutment portion and has an opening and an outer surface, the movable door structure comprising:
a bracket, disposed in the machine shell and comprising at least one curved slide rail, wherein the at least one curved slide rail comprises a first section and a second section communicating with each other, and there is a bending angle between a first extension direction of the first section and a second extension direction of the second section;
a door panel, disposed on the bracket and suitable for sliding along the at least one curved slide rail, wherein the door panel has an exterior surface and an inner surface opposite to each other; and
an elastic element, connected between the inner surface of the door panel and the abutment portion of the machine shell, wherein when the elastic element pushes against the door panel, so that the door panel is located in a first position, the door panel covers the opening of the machine shell, and the exterior surface of the door panel is aligned with the outer surface of the machine shell.

2. The movable door structure according to claim 1, wherein the bending angle is between 10 degrees and 45 degrees.

3. The movable door structure according to claim 1, wherein the at least one curved slide rail of the bracket comprises a first curved slide rail and a second curved slide rail, the bracket further comprises a first side panel and a second side panel parallel to each other, the first curved slide rail is disposed on the first side panel, and the second curved slide rail is disposed on the second side panel.

4. The movable door structure according to claim 3, wherein the door panel comprises a body and two bolts, the body is located between the first curved slide rail and the second curved slide rail, the two bolts are respectively inserted into the first curved slide rail and the second curved slide rail and are suitable for sliding along the first curved slide rail and the second curved slide rail, so that the door panel moves between the first position and a second position.

5. The movable door structure according to claim 4, wherein a shape of the opening of the machine shell matches a shape of the body of the door panel, and a thickness of the body is equal to a diameter of the opening.

6. The movable door structure according to claim 3, wherein the bracket further comprises a support panel and an extension panel, the support panel connects the first side panel and the second side panel, a third extension direction of the support panel is perpendicular to a fourth extension direction of the first side panel and the second side panel, the extension panel is connected to the support panel, and a fifth extension direction of the extension panel is parallel to the fourth extension direction of the first side panel and the second side panel.

7. The movable door structure according to claim 6, wherein the bracket further comprises a buckle portion disposed on a lower surface of the extension panel and facing the elastic element.

8. The movable door structure according to claim 7, wherein there is an accommodation space between the bracket and the machine shell, when an accessory pushes against the exterior surface of the door panel and enters the accommodation space, the buckle portion buckles the accessory to limit a movement of the accessory, and the door panel resists an elastic force of the elastic element and is located at a second position, and the accommodation space accommodates the door panel and the elastic element.

9. The movable door structure according to claim 7, wherein the first side panel, the second side panel, the support panel, the extension panel, and the buckle portion are integrally formed.

10. The movable door structure according to claim 7, wherein the buckle portion has flexibility.
